(19) United States
(12) Patent Application Publication
(10) Pub. No.: US 2002/0194586 A1
(43) Pub. Date: Dec. 19, 2002

(54) Method and system and article of manufacture for multi-user profile generation

(76) Inventors: Srinivas Gutta, Buchanan, NY (US); Kaushal Kurapati, Yorktown Heights, NY (US); Miroslav Trajkovic, Ossining, NY (US)

Correspondence Address: Russell I. Gross, PHILIPS ELECTRONICS NORTH AMERICA CORPORATION, 580 White Plains Road, Tarrytown, NY, 10591, US

(21) Appl. No.: 09/882,158

(22) Filed: Jun. 15, 2001

(51) Int. Cl. H04N 7/16

(52) U.S. Cl. 725/10; 725/74

(57) ABSTRACT

A system, method, and article of manufacture suitable for automatically generating recommendations of a set of entertainment options from a larger set of entertainment options based on user preferences for those options. In particular, the present invention relates to the field of automatically generating recommendations for viewing television programs based on past viewing patterns and preferences of a plurality of television viewers, all of whom do not need to be physically present in front of the television. The present invention creates a composite user profile based on individual profiles for each user detected who is to be used in the composite user profile, some of whom need not be present in front of the television. Each user's preferences may be weighted the same as each other user's or users may have differing weights assigned to their preferences.

### BACKGROUND OF THE INVENTION

1. Field of the Invention

The present invention relates to the field of generating recommendations for a set of options based on user preferences for those options. In particular, the present invention relates to the field of generating recommendations for a set of options based on past patterns of option selection by users of those options. In greater particularity, the present invention relates to the field of automatically generating recommendations for viewing television programs based on past viewing patterns and preferences of a plurality of television viewers, all of whom do not need to be physically present in front of the television.

2. Description of the Related Art

A television program viewer often has more than a few choices from which to select a program for viewing, sometimes even having hundreds of such choices. Additionally, viewers often have preferences about what programs they like, in general as well as specifically.

As the choices of programming increase, numerous methods for providing information regarding the content of the programming have been proposed. For example, U.S. Pat. No. 6,115,057, to Kwoh et al., teaches extracting rating data from a program video segment, the rating data indicating a rating level of the program video segment.

U.S. Pat. No. 6,020,883 to Herz et al. teaches developing customer profiles for recipients describing how important certain characteristics of the broadcast program are to each customer. From these profiles, an agreement matrix is calculated, embodying the attractiveness of each such program to each recipient based on their profile.

U.S. Pat. No. 5,585,865 to Amano et al teaches receiving a television signal in which genre codes are included. Amano '865 teaches comparing the broadcast genre code with an entered genre code for all receivable channels and, if a program exists for which the genre codes match, tuning in that channel. Amano '865 also teaches tuning into channels having a past record of highest frequency of reception.

U.S. Pat. No. 5,945,988 to Williams et al teaches a method and apparatus for automatically determining and dynamically updating user preferences in an entertainment system. Williams '988 allows for a plurality of system users and provides for automatic detection of which of the system users is currently using the entertainment system.

However, there is no teaching or suggestion in the prior art for establishing the identity of more than one person in a viewing area, either in front of or within a certain distance of a television or other entertainment system, and creating a composite user profile using those users preferences. The prior art does not teach or suggest a system which automatically detects the plurality of users and decides which shows are to be recommended or shown depending upon which shows are being transmitted during a time-frame that further meet or exceed a rating using a composite user profile. The prior art also does not teach or suggest recommending only those choices that receive high ratings from all the individual profiles.

Furthermore, the prior art does not teach or suggest automatically creating viewing recommendations based on changeable user preferences that depend, at least in part, on predetermined weighting factors set by the users.

### SUMMARY

The present invention comprises a system, method, and article of manufacture suitable for automatically generating recommendations of a set of preferred entertainment options from a larger set of available entertainment options based on user preferences of one or more users present in a predefined viewing area. In an exemplary embodiment, the present invention relates to automatically generating recommendations for viewing television programs based on past viewing patterns and preferences of a plurality of television viewers, all of whom do not need to be physically present in front of the television. The present invention creates a composite user profile based on individual profiles for each user detected who is to be used in the composite. Differing methods of creating the composite user profile may be employed. By way of example and not limitation, each user's preferences may be weighted the same as each other user's, or users may have differing weights assigned to their preferences.

### BRIEF DESCRIPTION OF THE DRAWINGS

These and other features, aspects, and advantages of the present invention will become more fully apparent from the following description, appended claims, and accompanying drawings in which:

FIG. 1 is a generally perspective schematic view of an exemplary embodiment of the present invention; and

FIG. 2 is a flow diagram of an exemplary method of the present invention.

### DETAILED DESCRIPTION OF A PREFERRED EMBODIMENT

In general, throughout this description, if an item is described as implemented in software, it can equally well be implemented as hardware.

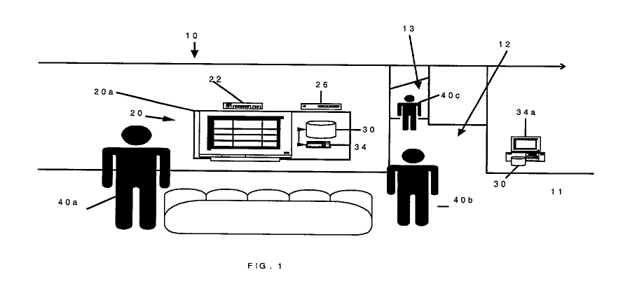

Referring now to FIG. 1, the present invention is suitable for use with an entertainment system 20 such as television 20a. However, entertainment system 20 can include radio, other audio entertainment, broadcast and non-broadcast audio-visual entertainment such as cable or satellite or DVD systems, or the like. Entertainment system 20 comprises persistent data store 30 such as a hard drive or non-volatile RAM (NVRAM) capable of storing individual user preference data for up to a corresponding plurality of entertainment system users, generally referred to herein by the numeral “40.” The user preferences further comprise view histories for each user 40. As used here, “view history” means an accumulation of entertainment options user 40 previously selected over some predetermined time frame. In a preferred embodiment, the system of the present invention may make an assumption that when user 40 selects a particular entertainment option, user 40 likes it and wants the system to recommend similar entertainment options in the future.

Detection system 22 senses when a user 40 such as user 40a or 40b is in a predetermined viewing area 11 proximate television 20a. As used herein, “viewing area” may include not only the physical space proximate television 20a such as viewing area 11 but one or more adjacent viewing areas as well such as viewing areas 12 and 13 desired by a user 40 with authority to make set viewing area 11 boundaries.

Detection system 22 may be of any such system as will be familiar to those of ordinary skill in the detection arts, including by way of example and not limitation input devices such as a television remote, biometric devices, set top boxes having recognition systems, voice recognition systems, and the like, or a combination thereof. As used herein, “biometric devices” may include a voice recognition system, a fingerprint recognition system, a handprint recognition system, and the like, or combinations thereof. Face and Hand Gesture Recognition Using Hybrid Classifiers by Gutta et al and published in the Proceedings of the Second International Conference on Automatic Face and Gesture Recognition by the Computer Society of the Institute of Electrical and Electronic Engineers, Inc. and Maximum Likelihood Face Detection by Colmenarez et al published in the Proceedings of the Second International Conference on Automatic Face and Gesture Recognition by the Computer Society of the Institute of Electrical and Electronic Engineers, Inc. are two examples of biometric recognition prior art.

Profile processor 34 is communicatively coupled to persistent data store 30 and detection system 22. As used herein, “profile processor” comprises a computer such as personal computer 34a, a microprocessor based system such as a microprocessor system embedded within or directly built into an entertainment system 20 such as profile processor 34, an application specific integrated circuit, an external device such as set top box 26 comprising a microprocessor based system, and the like, or any combination thereof. Profile processor 34 is capable of monitoring interaction of user 40 with entertainment system 20; recording that interaction with entertainment system 20 as well as the view history for each user 40; and creating, manipulating, storing, and maintaining user profiles in persistent data store 30.

Using detection system 22, profile processor 34 automatically detects which users 40 of the plurality of entertainment system users 40 are currently using entertainment system 20 or are within viewing area 11 of entertainment system 20. Using these detected users 40, profile processor 34 automatically creates a composite user profile based on the profiles of each of the plurality of users 40 currently in viewing area 11.

Each user profile may comprise a view history as well as preferences for the user 40. Additionally, users 40 with appropriate access rights may be allowed to modify their profile, by way of example and not limitation selecting from a set of predefined preference categories. These categories may include genre of entertainment options preferred, e.g. type of music or television program type. Additionally, a user 40 may rank order entertainment options by user preference, time of day viewing preferences, combinatorial preferences, or the like, or any combination thereof. “Combinatorial preference” as used herein means a set of preferences about how to handle preferences of a user 40 in light of other users 40 who may be present in viewing area 11. For example, a given young adult 40a with small children 40c may not have a strong preference for children's cartoon programming but may have a profile preference that rates children's cartoon programming very highly if a three year old 40c is present in viewing area 11.

Entertainment options that rate at or above a threshold value may be considered a “positive” program for a user 40. Accordingly, those entertainment options that do not rate at or above a threshold value may be considered a “negative” program for a user 40. Given the view history of a user 40, the system of the present invention generates a set of negative entertainment options such as by sampling an available database of all entertainment options, where the database is of the type familiar to those of ordinary skill in the software programming arts.

In an exemplary embodiment, the present invention uses a uniform random distribution to generate the negative entertainment options. By way of example and not limitation, the exemplary method selects each entertainment option from a database of all available entertainment options for entertainment options in the database that are not in the set of positive entertainment options for user 40. Additionally, this generation of the negative set of entertainment options may be limited, for example by a predetermined time frame, such as within a week from that day.

Additionally, an adaptive technique may be used, such as disclosed in U.S. patent application Ser. No. 09/819286, by Gutta, et al, for An Adaptive Sampling Technique for Selecting Negative Examples for Artificial Intelligence Applications, filed Mar. 28, 2001. The adaptive sampling technique picks entertainment options more closer to the positive entertainment options and uses implicit, explicit, and feedback techniques for generating recommendations for individual users 40. Implicit techniques involve having a system being aware of what entertainment options appeal to each user 40, e.g. what each user watches or listens to; capturing the entertainment option preference patterns of the users 40; and recommending entertainment options based on those captured pattern options. As used herein, “capture” includes, by way of example and not limitation, storing predetermined data in the user profile for the user 40 such as in the view history of the user 40. Explicit techniques involve having users 40 specify viewing preferences and then using these specified preferences to recommend entertainment options to a user 40. A third technique involves having a system elicit specific feedback from a user 40 and then generate a set of recommendations based on the feedback from the user 40. Additionally, a technique may be used that combines all the above.

In the operation of an exemplary embodiment, as opposed to the prior art, the present invention addresses making a set of entertainment option recommendations based on a plurality of users 40, not just a single user 40. Accordingly, in one exemplary embodiment, the system first identifies each of the users 40 in viewing area 11 and then presents entertainment option recommendations limited to those entertainment options having a common rating by users 40 in viewing area 11, e.g. members of the household even if they are not physically present in the same room. By way of example and not limitation, if three year old user 40c mentioned above is not in the same room 11 as television 20a but is within line of sight or within hearing range of television 20a, such as in room 13, parent 40a of three year old user 40c may want to have the presence of three year old user 40c taken into account when having recommendations presented. For example, if three year old user 40c is in a kitchen and television 20a in a den adjacent to the kitchen, parent 40a may still opt to have children's cartoon programming more highly recommended than a movie station.

When all users 40 in viewing area 11 are detected and identified, a profile for each user 40 identified is retrieved for further processing. Users 40 who are detected but not identified or who do not have a profile established may be represented by a default profile. The profiles of detected users 40 are then combined in a predetermined manner into a composite user profile and a list of entertainment option recommendations is generated and made available to users 40 in viewing area 11 that reflects the composite user profile.

In a first currently envisioned embodiment, combining profiles is accomplished by first accumulating positive entertainment options and generating negative entertainment options for each positive entertainment options for each profile retrieved for the detected users 40. A composite user profile is then created wherein each of the profiles of the detected users 40 is equally weighted in creating the composite user profile. The creation of the composite user profile may be by implicit, explicit, or feedback techniques or any combination thereof. The available entertainment options are retrieved from a database or other source of available entertainment options for a given time frame, e.g. currently or currently through the next two hours, and analyzed against the composite user profile to create a set of values for entertainment option recommendation. Entertainment options are selected from the set of all or a predetermined subset of all available entertainment options such as by recommending only those entertainment options being transmitted during the selected time-frame that are at or above a predetermined threshold value. In currently envisioned alternate embodiments, a user can be presented with a display indicating only the recommended options, all options in which recommended options are distinguishable such as visually, or a configurable set of recommended, positive options as well as non-recommended, negative options.

In a currently contemplated alternative, instead of generating a composite user profile, the available entertainment options are analyzed and rated against a previously created (or default) profile of each user 40 present in viewing area 11. Only when an entertainment option is rated at or above a predetermined threshold value by all of these users 40 will that entertainment option be recommended.

Variations of this alternative are also envisioned. For example, each user 40 could be weighted differently such that preferences of certain users 40 are taken into account more than the preferences of other users 40. Additionally, instead of requiring that all users 40 rate an entertainment option at or above a threshold, a simple or weighted “majority rules” decision, or other rules based decision, could occur. Furthermore, weighting factors, if used, may be varied as a function of time of day, e.g. a profile for user 40a may be weighted more heavily at night than during the day when compared to the profile for user 40c.

Other techniques are also currently envisioned. By way of example and not limitation, a father and daughter may both enjoy sports in general. The father may also enjoy entertainment options involving cooking which the daughter hates and the daughter may enjoy entertainment options involving music which the father does not. If the father and daughter are both watching television 20a, the system may generate a composite user profile, analyze the available television programming, and then recommend a tennis match and a sports news program. If the father's preferences are weighted more heavily than the daughter by the system, a cook-off broadcast may also get recommended even though it would not be recommended for the daughter if she were watching alone.

As a further example, if a mother and her three year old child are watching together, in one embodiment only entertainment options that are highly recommended by the three year old's profile would be displayed even though those entertainment options are not highly rated for the mother.

In addition to view histories, the system can use other attributes in its decision processes. By way of example and not limitation, weighting factors for a given user 40 may change based on time of day. For example, a three year old child may have the highest priority in the morning, but the mother may have the highest priority in the evening. By way of further example, the three year old child's priority may be zero in the evening.

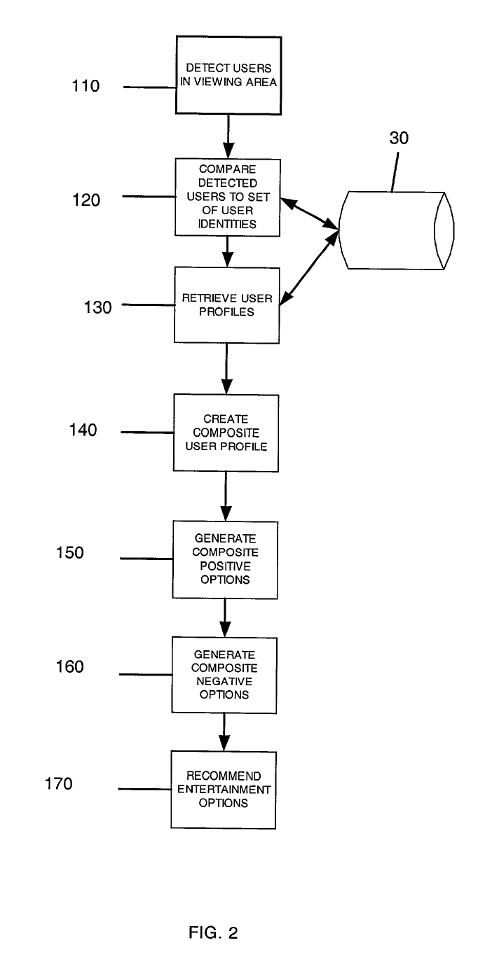

Referring now to FIG. 2, when television 20a is powered on or otherwise triggered, such as by a timer, detection system 22 detects 110 users 40 who are within predetermined viewing area 11.

Profile processor 34 then determines the identity of the detected users 40. In an exemplary embodiment, the identities of the detected users 40 are compared 120 against a set of users identities stored in persistent data store 30. As noted above, persistent data store 30 may be a part of television 20a of may be accessible to the television 20a such as a hard drive on personal computer 34a operatively connected to the television by connection means familiar to those of ordinary skill in the data communication arts.

Profiles for the detected users 40 are then retrieved 130 from persistent data store 30. Users 40 who cannot be identified or users 40 who otherwise have no accessible profile may be assigned a default profile 135.

Once the profiles are obtained, a composite user profile is created 140 using all of the retrieved profiles. In a currently preferred embodiment, a composite user profile is created by first creating a composite view history 132 from each view history stored in the stored preferences for each user 40 identified.

Currently, several techniques of creating a composite user profile are envisioned although others will be familiar to those of ordinary skill in the computer arts. In a first technique, all profiles gathered are combined arithmetically to create a non-weighted sum of all profiles of the identified users 40. Those entertainment options of the resulting composite user profile reflecting entertainment option preferences having the greatest arithmetic value are presumed to be entertainment options having the greatest appeal to the users 40 in viewing area 11.

In a second technique, all profiles gathered are combined arithmetically where the preferences of each detected and identified user 40 are further manipulated according to a predetermined weight, such as by multiplying, to create a weighted sum of all profiles of the detected and identified users 40. As with the first technique, those entertainment options of the resulting composite user profile having the greatest resulting arithmetic value are presumed to be entertainment options having the greatest appeal to the users 40 in viewing area 11.

In a third technique, all profiles gathered are combined by including only those components of each profile of each detected and identified user 40 that equal or exceed a predetermined threshold value. All entertainment options at or above this threshold are presumed to be entertainment options having the greatest appeal to the users 40 in viewing area 11.

From the composite user profile, the system generates 150 a set of composite positive entertainment options. Generation of the composite positive entertainment option set may be accomplished by numerous techniques as will be familiar to those of ordinary skill in the software programming arts including using uniform random distribution whereby a user 40 may be allowed to select an entertainment option from a database of all available entertainment options for every entertainment option in the positive set. This may include making sure the entertainment option that has been picked is not part of the positive set and occurs from the same time frame, such as within a one week period. Alternatively, generation of the composite positive entertainment option set may be accomplished by an adaptive sampling technique which selects entertainment options that are closer to the positive entertainment options. Methods for adaptive television program recommendations based on a user profile are discussed in Adaptive TV Program Recommender, U.S. Ser. No. 09/498,271, filed Feb. 4, 2000, incorporated by reference in its entirety herein.

In a further alternative, generation of the composite positive entertainment option set may use implicit techniques, explicit techniques, feedback techniques, or a combination thereof.

Additionally, a set of composite negative entertainment options may be generated 155 by sampling the database of all entertainment options. The set of composite negative entertainment options may be stored for future use.

Once the sets of positive and negative programs are created, scores for each member of the sets may be generated 160 from the composite user profile. As used herein, “scores” comprises numerical values associated with each member of the sets of positive and negative entertainment options by which each member of the sets of positive or positive and negative entertainment options are able to be gauged against other members of that set and/or against a predetermined threshold for use in generating recommended members of the set. Scores may be generated using the preferences or the composite preferences. In a currently preferred embodiment, scores are generated only for positive entertainment options. In a further exemplary embodiment, recommendations may be generated from the set of entertainment options matching a score threshold but limited to a predetermined time frame. By way of example and not limitation, scores may be generated to determine which of the available entertainment options are to be recommended based on the plurality of users 40 by rating the entertainment options of a predetermined time frame against each of the previously created individual profiles of each user 40 present in viewing area 11 and then presenting only the entertainment options that meet or exceed a predetermined rating threshold in each of the each of the previously created individual profiles of each user 40 present in viewing area 11.

Additionally, one or more users 40 may be designated as having rights, such as access rights or supervisory rights, that are different than the rights of other users 40. By way of example and not limitation, a profile for a user such as user 40b may indicate that that user 40b is enabled to alter rules and weighting methods, add or modify other profiles, or the like, whereas users 40a and 40c may not.

It will be understood that various changes in the details, materials, and arrangements of the parts which have been described and illustrated above in order to explain the nature of this invention may be made by those skilled in the art without departing from the principle and scope of the invention as recited in the following claims.

What is claimed is:

1. An apparatus useful with an entertainment system, the apparatus comprising:
a. a persistent data store having a plurality of storage locations to store a plurality of user preference data for a corresponding plurality of entertainment system users, wherein individual storage locations are dedicated to store user preference data for an individual system user;
b. a user detection system; and
c. a profile processor, communicatively coupled to the persistent data store and the user detection system, the profile processor programmed to:
i. automatically detect which users of the plurality of entertainment system users are currently within a predetermined viewing area; and
ii. automatically create a composite user profile, useful for generating a set of recommended entertainment options from a set of available entertainment options, the composite user profile being based on the profiles of each of the plurality of users currently within the predetermined viewing area.

2. The apparatus of claim 1 wherein the user detection system comprises a computer vision system, a voice recognition system, a fingerprint recognition system, a handprint recognition system, and an input device capable of transmitting at least one unique input.

3. The apparatus of claim 2 wherein the computer vision system identifies faces in the detected imagery.

4. The apparatus of claim 1 wherein the profile processor is further programmed to monitor interaction of users with the entertainment system, selectively store a predetermined portion of each interaction in a view history, and selectively retrieve interactions from the view history.

5. The apparatus of claim 4 wherein the profile processor is further programmed to:
a. create at least one value relating to the view history of a user within that user's profile; and
b. create a set of recommend viewing choices for the composite user profile based at least in part on each detected user's past viewing history for viewing choices similar to or the same as the viewing choices in those users' past viewing histories.

6. An entertainment system, comprising:
a. at least one entertainment system component providing programming available to at least one user, the programming being received via at least one input to the entertainment system component;
b. a persistent data store having a plurality of storage locations to store user preference data for a corresponding plurality of entertainment system users, wherein at least one unique storage location is dedicated to store the user preference data for a unique corresponding system user; and
c. a profile processor, operatively in communication with the at least one entertainment system component, the persistent data store, and a user detection system, the profile processor programmed to:
i. automatically detect which users of the plurality of entertainment system users are currently within a predefined viewing area;
ii. automatically create a composite user profile based on a profile for each of the plurality of users currently detected within the predefined viewing area; and
iii. dynamically adjust operating parameters for the entertainment system in response to the composite user profile.

7. A method for creating a composite user profile for a plurality of users, the method comprising:
a. automatically detecting which of a plurality of users are currently within a predetermined viewing area;
b. determining an identity for each of the detected plurality of users;
c. for each identified user,
i. comparing the user's identity against a first predetermined portion of user data stored in a persistent data store; and
ii. retrieving a second predetermined portion of user data from the persistent data store for each user with a user profile stored in the persistent data store; and
d. creating a composite user profile from each of the second predetermined portions of user data.

8. The method of claim 7 further comprising creating a set of recommended entertainment options based on the composite user profile from a set of available entertainment options.

9. The method of claim 7 further comprising:
e. accumulating a view history for each detected user, the view history comprising positive entertainment options;
f. creating a composite view history from the accumulated view histories, the composite view history comprising positive entertainment options;
g. adjusting the composite user profile using the positive entertainment options in the composite view history wherein each positive entertainment option in the composite user profile reflects a sum of occurrences of that positive entertainment option in each of the individual user's profiles;
h. generating negative entertainment options for each positive entertainment option in the composite user profile;
i. determining which entertainment options available in a predetermined time frame are positively rated by the composite user profile; and
j. generating a composite score for each positive entertainment option and negative entertainment option in the composite user profile.

10. The method of claim 7 wherein a user profile may be generated by an individual who has authority to generate a user profile for users who are present but who have no profile.

11. The method of claim 7 further comprising:
e. creating a composite view history to reflect each view history stored in the stored user data for each user identified;
f. generating a set of positive entertainment options from a set of available entertainment options for that available entertainment options that meet or exceed a predetermined threshold value of positive entertainment options in the composite view history; and
g. generating a set of negative entertainment options by sampling the set of available entertainment options that do not meet the predetermined threshold value of positive entertainment options in the composite view history.

12. The method of claim 11 wherein step (g) further comprises using a uniform random distribution to create a set of negative options.

13. The method of claim 11 further comprising:
h. allowing a user to select an entertainment option from the set of positive entertainment options; and
i. preventing selection of an available entertainment option for entertainment options that are members of the set of negative entertainment options.

14. The method of claim 13 wherein step (i) further comprises restricting negative entertainment options to those that occur within a predetermined time frame.

15. The method of claim 11 wherein step (f) further comprises using an adaptive sampling technique to select entertainment options from all available entertainment options such that the selected entertainment options match preferences in the composite user profile within a predetermined range.

16. The method of claim 11 further comprising:
h. generating entertainment option recommendations based on available entertainment options and the set of positive entertainment options using implicit selection techniques, explicit selection techniques, feedback selection techniques, or a combination thereof.

17. The method of claim 16 wherein the implicit selection techniques comprise capturing users' entertainment option selection patterns and generating entertainment option recommendations based on a composite of the users' entertainment option selection patterns.

18. The method of claim 16 wherein the explicit selection techniques comprise having the users explicitly input each of the user's entertainment option preferences and generating entertainment option recommendations based on a composite of the users' explicit entertainment option preferences.

19. The method of claim 11 further comprising:
h. capturing users' entertainment option selection patterns;
i. accepting at least one of the users' explicit input of the user's entertainment option preferences; and
j. generating entertainment option recommendations based on a composite of the users' entertainment option selection patterns and on a composite of the users' explicit entertainment option preferences.

20. The method of claim 11 wherein step (e) further comprises:
i. generating scores for each of the detected users from each of the detected users' profile data; and
ii. combining the detected users' profiles using the generated scores.

21. The method of claim 20 wherein each user's individual user profile may further comprise a weighting factor such each detected user's preferences are weighted independently from other users detected in the viewing area when generating scores for the detected users from each of the detected users' profile data.

22. The method of claim 21 wherein the weighting factor can vary as a function of time of day or calendar time.

23. The method of claim 11, further comprising:
h. rating available entertainment options for a predetermined time frame against each of the previously created individual profiles of each user detected in the viewing area; and
i. presenting only entertainment options that meet or exceed a predetermined rating threshold in each of the previously created individual profiles of each user present in the viewing area.

24. In an entertainment system including a program processor operatively connected to a persistent data store, a program output device, an audio input device, a user detection device, and a video input device, a method for automatically configuring the entertainment system for an plurality of identified system users, the method comprising:
j. detecting which users from the plurality of identified system users are currently within a predetermined viewing area;
k. determining which of the detected users have user preference data stored in the persistent data store;
l. retrieving the user preference data corresponding to each of the detected users from the persistent data store for those detected users having profiles in the persistent data store;
m. creating a composite user profile using the retrieved user preference data;
n. scanning programming information for available entertainment options which match the composite user profile within a predetermined range of matching values; and
o. adjusting the entertainment system in accordance with the composite user profile and available entertainment options.

25. A computer program embodied within a computer-readable medium created using the method of claim 7.

26. A computer program embodied within a computer-readable medium created using the method of claim 24.
